(19) United States
(12) Patent Application Publication
(10) Pub. No.: US 2017/0326012 A1
(43) Pub. Date: Nov. 16, 2017

(54) DISPOSABLE THERAPEUTIC BED LINEN

(71) Applicant: Science Medical, LLC, Saratoga Springs, UT (US)

(72) Inventors: Jeff BULLOCK, Saratoga Springs, UT (US); John K. BULLOCK, Saratoga Springs, UT (US)

(21) Appl. No.: 15/528,446

(22) PCT Filed: Nov. 19, 2015
(86) PCT No.: PCT/US2015/061701

§ 371 Date: May 19, 2017

Related U.S. Application Data
(60) Provisional application No. 62/082,010, filed on Nov. 19, 2014.

(51) Int. Cl. A61G 7/10; A47G 9/00

(52) U.S. Cl. CPC A61G 7/1026; A47G 9/007

(57) ABSTRACT

A disposable bed linen for use in a healthcare facility, the bed linen having a therapeutic sensory feature comprising at least one of a scent, a color, a texture, and a pattern. The disposable bed linen may further include a structural feature to assist the user's comfort, to assist the user in moving around on the user contact surface of the bed linen, and/or to assist a user in lifting the bed linen as part of transferring the user.

### BACKGROUND OF THE INVENTION

The present invention relates generally to a disposable bed linen. In one instance, the present invention relates to a disposable bed linen for use in the medical field. In another instance, the present invention relates to a disposable bed linen for use in the hospitality field, namely hotels, resorts, lodging, timeshares, clubs, and the like. In particular, the present invention relates to a disposable bed linen having various characteristics and properties configured to impart wellness and comfort to a user's senses, namely the user's mind, body, and spirit. The invention further relates to a disposable bed linen having various structural features to assist in the user's physical comfort, mobility, and, in some instances, to assist others in moving the user. The invention further relates to various clothing items, such as scrubs, robes, pajamas, and the like, which may include one or more of the various characteristics and properties of the present invention.

Soiled hospital bed linens constitute one of the largest concentrations of microbial contamination in the hospital environment. An estimated 6 billion pounds of hospital bed linens are used each year in American hospitals. This abundance of soiled hospital linens places an enormous responsibility on the laundry department whose job is to return these soiled linens to service in a clean and safe condition, free of contaminants and microorganisms, which otherwise could cause cross-infection throughout the facility. Adequate procedures for collection, transportation, processing, and storage of clean and soiled hospital linens are a necessary protocol in order to limit the possibility of infection in patients and staff who may be unusually susceptible. Further, in some countries theft of bed linens is an ongoing challenge.

Disposable bed linen is increasingly used in developed countries, particularly in healthcare facilities. These have particular application in areas of healthcare with a high daily turnover of patients, usually emergency care wards, outpatients and support services such as diagnostics and treatment centers, X-Ray, MRI facilities and on gurneys and ambulance stretchers. Attempts are generally made to design and make disposable bed linens which mimic the style, feel and features of non-disposable bed linens. As such, disposable bed linens typically resemble non-disposable bed linens. Each bed in a healthcare facility is dressed with an identical, disposable bed linen irrespective of the patient for whom the bed is prepared. Disposable bed linens used in other industries are similarly identical, irrespective of the user for whom the bed is prepared. Further, currently available disposable bed linen is devoid of various features that may be useful to the comfort and wellness of the patient and/or user. The present invention addresses and solves these shortcomings.

### BRIEF SUMMARY OF THE INVENTION

The present invention relates generally to a disposable bed linen. In one instance, the present invention relates to a disposable bed linen for use in the medical field. In another instance, the present invention relates to a disposable bed linen for use in the hospitality field, namely hotels, resorts, lodging, timeshares, clubs, massage therapy, retail (over-the-counter) and the like. In particular, the present invention relates to a disposable bed linen having various characteristics and properties configured to impart wellness and comfort to a user's senses, namely the user's mind, body, and spirit. The invention further relates to a disposable bed linen having various structural features to assist in the user's physical comfort, mobility, and, in some instances, to assist others in moving the user. The invention further relates to various clothing items, such as scrubs, hospital gowns, robes, pajamas, and the like, which may include one or more of the various characteristics and properties of the present invention.

In some implementations of the present invention, a disposable bed linen is provided having one or more therapeutic sensory features configured to impart wellness and/or comfort to a user. In one aspect of the invention, a disposable bed linen is provided having a therapeutic sensory feature comprising at least one of a color, a scent, a texture, and/or a coefficient of friction (COF) that imparts wellness and/or comfort to a user. In one aspect of the invention, a disposable bed linen is provided having a therapeutic sensory feature comprising a scent which is derived from one or more essential oils. In one aspect of the invention, a disposable bed linen is provided having a therapeutic sensor feature comprising a scent which is derived from at least one of a naturally occurring chemical and a synthetically derived chemical.

In some implementations of the present invention, a disposable bed linen is provided having one or more structural features to assist the physical comfort of the user. In one aspect of the invention, a disposable bed linen is provided having one or more surface areas having a high COF to increase traction or grip between the patient and the patient contact surface of the linen. In some instances, the area of high COF corresponds to at least one of the patient's hands, elbows, forearms, and/or heels.

In some implementations of the present invention, a disposable bed linen is provided having one or more structural features to assist in lifting and moving the patient and disposable bed linen as part of a patient transfer. In one aspect of the invention, a disposable bed linen is provided having a plurality of handholds formed in the sidewalls of the disposable bed linen, wherein the handholds are grasped and used to lift the patient while lying on the contact surface of the bed linen.

In some implementations of the invention, a disposable clothing item is provided having one or more therapeutic sensory features configured to impart wellness and/or comfort to a user. In one aspect of the invention, a disposable clothing item is provided having a therapeutic sensory feature comprising at least one of a color, a scent, a texture, and/or a coefficient of friction (COF) that imparts wellness and/or comfort to a user. In one aspect of the invention, a disposable clothing item is provided having a therapeutic sensory feature comprising a scent which is derived from one or more essential oils. In one aspect of the invention, a disposable clothing item is provided having a therapeutic sensor feature comprising a scent which is derived from at least one of a naturally occurring chemical and a synthetically derived chemical that is infused into the fabric.

### BRIEF DESCRIPTION OF THE SEVERAL VIEWS OF THE DRAWINGS

In order that the above-recited and other features and advantages of the invention are obtained and will be readily understood, a more particular description of the invention briefly described above will be rendered by reference to specific embodiments thereof, which are illustrated in the appended drawings. These drawings depict only typical embodiments of the invention and are not therefore to be considered to limit the scope of the invention.

FIG. 1, shown in parts A and B, shows a perspective view of a disposable bed linen having one or more therapeutic sensory features in accordance with a representative embodiment of the present invention.

FIG. 2 shows a perspective view of a disposable bed linen in accordance with a flow chart of a representative networking system that provides a suitable environment in which various embodiments of the present invention may be implemented.

FIG. 3 shows a cross-section end view of the disposable bed linen of FIG. 2 in accordance with a representative embodiment of the present invention.

FIG. 4 shows a cross-section side view of a disposable bed linen having head and foot cushion structures to assist the physical comfort of a patient in accordance with a representative embodiment of the present invention.

FIG. 5, shown in parts A and B, shows a top, plan view of the patient contact surface of a disposable linen, wherein the patient contact surface comprises one or more structural features having a high COF to increase traction or grip between the patient and the patient contact surface of the bed linen in accordance with a representative embodiment of the present invention.

### DETAILED DESCRIPTION OF THE INVENTION

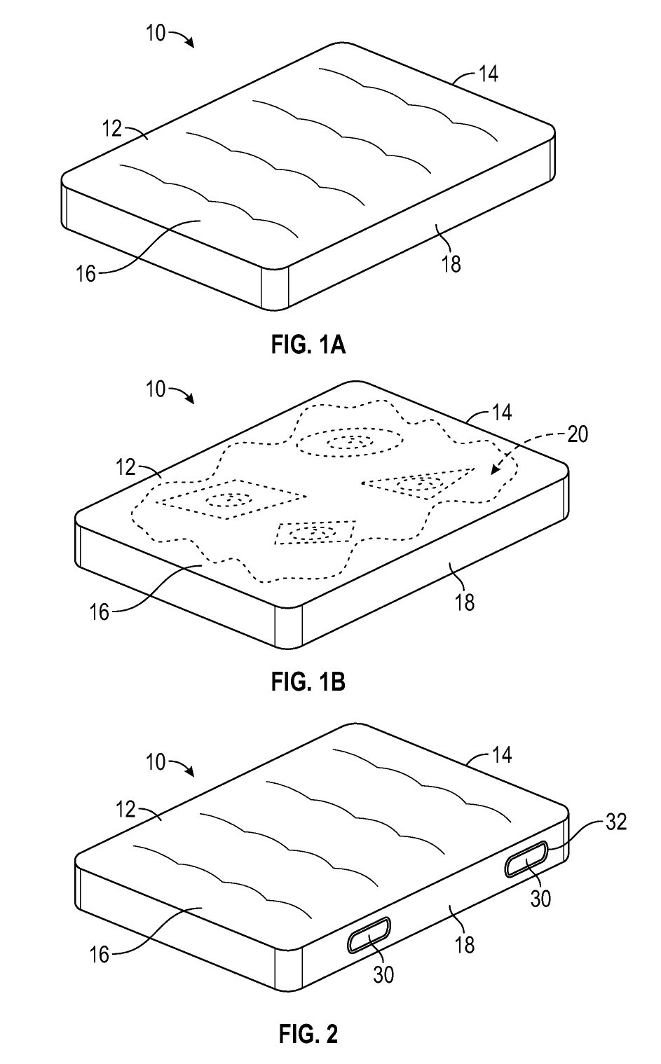

The presently preferred embodiments of the described invention will be best understood by reference to the Figures, wherein like reference numbers indicate identical or functionally similar elements. It will be readily understood that the components of the present invention, as generally described and illustrated in the Figures, could be arranged and designed in a wide variety of different configurations. Thus, the following more detailed description, as represented in FIGS. 1 through 5B, is not intended to limit the scope of the invention as claimed, but is merely representative of some presently preferred embodiments of the invention.

The present invention relates generally to a disposable bed linen for use in the medical field. In particular, the present invention relates to a disposable bed linen having various characteristics and properties configured to impart wellness and comfort to a user's senses, namely the user's mind, body, and spirit. The invention further relates to a disposable bed linen having various structural features to assist in the user's physical comfort, mobility, and to assist others in moving the user.

In particular, the present invention relates to a disposable bed linen having various features that may be customized to address the specific needs of user. In some embodiments, a disposable bed linen is provided comprising or consisting of a color that is determined to impart wellness and comfort to a user's senses, namely the user's mind, body, and spirit. In some embodiments, a disposable bed linen is provided comprising or consisting of a pattern or design that is determined to impart wellness and comfort to a user's senses, namely the user's mind, body, and spirit. In some embodiments, a disposable bed linen is provided comprising or consisting of a scent that is determined to impart wellness and comfort to a user's senses, namely the user's mind, body, and spirit. Further, in some embodiments a disposable bed linen is provided comprising or consisting of a texture and/or a COF that is determined to impart wellness and comfort to a user's senses, namely the user's mind, body, and spirit.

The present invention further relates to a disposable bed linen having one or more structural features to assist the user in their mobility on the user contact surface of the linen, and/or to assist others in lifting and moving the disposable linen to transfer the user to another bed or other desired surface.

Referring now to FIG. 1A, a disposable bed linen 10 is shown. Although shown as a fitted bed linen, the features of the instant invention are equally applicable to fitted sheets, flat sheets, top sheets, bottom sheets, coverlets, bedspreads, blankets, throws, comforters, duvets, duvet covers, pillows, pillow cases, pillow shams, and bed skirts, as well as other types of compatible bedding. Some features of the instant invention may also be applicable to other types of disposable, user materials, such as user gowns, scrubs, robes, slippers, hairnets, gloves, hats, towels, washcloths, face towels, bathmats, and tablecloths. In some embodiments, the present invention comprises a set of disposable user materials for use by the user during their stay in a healthcare facility, wherein the set includes two or more disposable user materials selected from the group consisting of bed linens, fitted sheets, flat sheets, top sheets, bottom sheets, coverlets, bedspreads, blankets, throws, comforters, duvets, duvet covers, pillows, pillow cases, pillow shams, bed skirts, user gowns, slippers, hairnets, gloves, hats, towels, washcloths, face towels, bathmats, and table clothes.

Disposable bed linen 10 generally comprises a shape and construction that is commonly known and utilized with non-disposable bed linens. In some instances, disposable bed linen 10 comprises a top or user contact surface 12 having a head end 14 and a foot end 16. Where disposable bed linen 10 is a bottom or fitted sheet, linen 10 further comprises a sidewall 18. Disposable bed linen 10 may comprise any size and is generally sized to fit standard bed sizes, such as a standard hospital bed. Disposable bed linen 10 may further be sized to fit a gurney, a stretcher, or an examination table.

In some instances, disposable bed linen 10 comprises a color that is configured to impart wellness and comfort to a user's senses, namely the user's mind, body, and spirit. Colors are capable of influencing many aspects of the user's healing, including the user's mood, mental state and energy level. In some aspects, a color is selected for its ability to affect one or more of the user's energy centers in order to balance the user.

For example, in some embodiments a disposable bed linen is provided comprising or consisting of a red color, wherein the red color is selected to stimulate and boost the physical energy of the user, strengthen the user's willpower, increase circulation in the user, assist in clearing the user's congestion, and/or assist the user with a sexual ailment. In some embodiments, a disposable bed linen is provided comprising or consisting of an orange color, wherein the orange color is selected to encourage joy, socializing and/or optimism in the user, such as to assist the user in overcoming depression. In some instances, the color orange is selected to assist the user in recovering from indications involving the kidneys, the urinary tract, and the reproductive organs.

In some instances, a disposable bed linen is provided comprising or consisting of a yellow color, wherein the yellow color is selected to combat a user's fear, apprehension, confusion, lack of determination, and/or the user's introversion or power issues. In some instances, a disposable bed linen is provided comprising or consisting of a green color, wherein the green color is selected to encourage the user's emotional stability, purity and calmness. In some instances, a disposable bed linen is provided comprising or consisting of a blue color, wherein the blue color is selected to assist the user with an indication involving the user's throat and/or lungs. A blue color may also be selected to enhance the user's verbal expression and communication, artistic expression and/or willpower. In some instances, a blue color is selected to assist the user in overcoming insomnia, anxiety, throat problems, high blood pressure, migraines, and/or skin irritations.

In some embodiments, a disposable bed linen is provided comprising or consisting of an indigo color, wherein the indigo color is selected to encourage the user's intuition and strengthen the lymph system, immune system, and/or help purify and cleanse the body. In some embodiments, a disposable bed linen is provided comprising or consisting of a purple or violet color, wherein the purple or violet color is selected to encourage the user's spirituality, intuition, wisdom, mastery, mental strength, and/or focus. In some embodiments, a disposable bed linen is provided comprising two or more colors.

Disposable bed linen 10 may further comprise a printed design or pattern 20, as shown in FIG. 1B. In some instances, disposable bed linen 10 comprises a pattern 20 that imparts wellness and/or comfort to a user. For example, in some embodiments a disposable bed linen is provided comprising or consisting of a pattern 20 that is familiar to a child user, wherein the familiar pattern 20 helps to alleviate the child user's anxiety. Pattern 20 may include one or more shapes, cartoon characters, colors, symbols, words or figures.

Referring now to FIGS. 1A and 1B, in some instances disposable bed linen 10 further comprises one or more scents that impart wellness and/or comfort to a user. As used here, the term “scent” is understood to describe and include any naturally occurring, or synthetically derived chemical having a distinctive smell. Non-limiting examples of suitable scents include essential oils, aromatic or aroma compounds, odorants, aromas, fragrances, oils, and flavors.

In some embodiments, scents compatible with the instant invention comprise a desirable and detectable odor which provides a therapeutic effect to the user. Non-limiting examples of compatible scents are provided herein. For example, in some embodiments a disposable bed linen is provided having one or more scents configured to relieve the user's anxiety, wherein the one or more scents are selected from the group consisting of lavender, melissa, myrrh, bergamot, cardamom, chamomile, cypress, frankincense, rose, pine, vanilla, marjoram, neroli, nutmeg, patchouli, orange and lime. In other embodiments, a disposable bed linen is provided having one or more scents configured to relieve the user's depression, wherein the one or more scents are selected from lemon, marjoram, neroli, peppermint, patchouli, rosemary, sandalwood, angelica, bergamot, cedarwood, jasmine, lavender, geranium, ylang ylang, and clary sage.

In other embodiments, a disposable bed linen is provided having one or more scents configured to relieve the user's fatigue, wherein the one or more scents are selected from the group consisting of basil, angelica, cedarwood, clove, eucalyptus, jasmine, frankincense, lemon, neroli, marjoram, peppermint, patchouli, and vanilla. In other embodiments, a disposable bed linen is provided having one or more scents configured to relieve the user's headaches, wherein the one or more scents is selected from the group consisting of basil, chamomile, cinnamon, ginger, eucalyptus, lavender, lemon grass, melissa, marjoram, peppermint, thyme, ylang ylang, and clary sage. In other embodiments, a disposable bed linen is provided having one or more scents configured to relieve the user's lung and/or sinus congestion, wherein the one or more scents are selected from the group consisting of angelica, basil, cedarwood, clove, cypress, eucalyptus, fennel, ginger, hyssop, juniper, rosemary, tea tree, and marjoram.

In other embodiments, a disposable bed linen is provided having one or more scents configured to relieve the user's indigestion, wherein the one or more scents are selected from the group consisting of lavender, juniper, lemon grass, lemon verbena, orange, peppermint, rose, rosemary, sandalwood, thyme, anise, fennel, ginger, and basil. In other embodiments, a disposable bed linen is provided having one or more scents configured to relieve the user's menstrual cramps, wherein the one or more scents is selected from the group consisting of angelica, basil, caraway, chamomile, ginger, clary sage, lavender, rose, rosemary, and sage. In other embodiments, a disposable bed linen is provided having one or more scents configured to relieve the user's muscle soreness, wherein the one or more scents is selected from the group consisting of bay, caraway, chamomile, eucalyptus, frankincense, ginger, geranium, juniper, lemon grass, lemon verbena, rosemary, sandalwood, patchouli and myrtle. In other embodiments, a disposable bed linen is provided having one or more scents configured to assist in healing the user's cancer, wherein the one or more scents is selected from the group consisting of frankincense, sacred frankincense, lavender, palo santo, wintergreen, Idaho balsam fir, copaiba, clove, ledum, myrrh, rose, and ylang ylang. In some embodiments, a disposable bed linen is provided comprising two or more scents.

In some instances, disposable bed linen 10 comprises a nonwoven fabric. As used herein, the term “nonwoven fabric” is understood to include material made from long fibers, bonded together by chemical, mechanical, heat or solvent treatment. In some embodiments, disposable bed linen 10 comprises a spunlace, microfiber polyester, or hydroentanglement fabric material. In some embodiments, disposable bed linen 10 comprises a polyethylene teraphlalate fabric material. Further, in some embodiments disposable bed linen 10 comprises or consists of a biodegradable material.

In some embodiments, disposable bed linen 10 comprises a texture that is similar to the user's personal home linens. As such, the user contact surface 12 feels familiar, comfortable and soothing to the user, thereby further alleviating user anxieties associated with the healthcare setting. In some instances, the user contact surface 12 comprises a COF that is similar to cotton or brushed cotton linens. In some instances, the user contact surface 12 comprises a COF that is similar to silk, satin or sateen linens. Further, in some instance the user contact surface 12 comprises a COF that is similar to jersey knit linens. In some instances, the user contact surface 12 comprises a COF that is similar to flannel linens.

Various embodiments of the present invention may further comprise one or more additional properties improve the user experience. For example, in one embodiment a disposable bed linen 10 further comprises one or more antimicrobial agents, applied as either a coating or infused within or otherwise crosslinked with the materials of the bed linen. In one embodiment, a disposable bed linen 10 further comprises a waterproof coating, such as TEFLON®, to render the bed linen impermeable to aqueous solutions. In one embodiment, a disposable bed linen 10 further comprises DRY-FIT® or other moisture wicking properties.

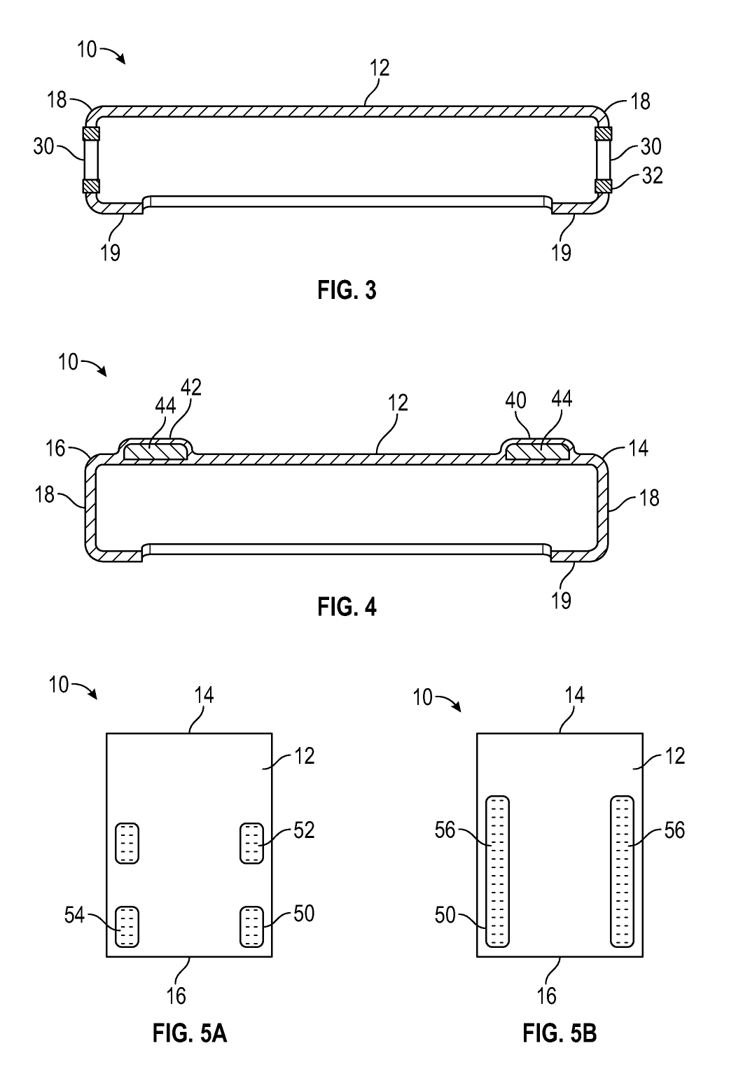

Referring now to FIGS. 2 and 3, in some instances disposable bed linen 10 further comprises a plurality of handles or handgrips 30 formed in sidewall 18. In some embodiments, handgrips 30 comprise windows formed in sidewall 18 having a length and width sufficient to accommodate a user's hand. Where linen 10 is a bottom or fitted linen, the user untucks the portion 19 of the sidewall 18 that is positioned under the mattress and grasps this portion and handgrip 30. In some instances, the perimeter edge 32 of handgrip 30 comprises reinforced stitching to prevent tearing or fabric failure. In some instances, the position of handgrips 30 on sidewall 18 is selected to align with one or more air vents (not shown) on the hospital bed mattress. As such, the windows of handgrips 30 permit the free flow of air into and out of the respective air vents.

Referring now to FIG. 4, in some instances disposable bed linen 10 further comprises one or more enclosures 40 and 42 to provide padding to the user's head and/or heels. In some embodiments, enclosures 40 and 42 comprise a pocket filled with a padding material 44. Although disposable bed linen 10 is shown having two enclosures 40 and 42, in some instances linen 10 comprises a single enclosure. Enclosures 40 and 42 are generally configured and positioned to provide additional padding under the user's head and feet (i.e. heels) when lying on user contact surface 12. In some instances, padding material 44 further comprises a moisture wicking material. In some instances, padding material 44 further comprises a heat absorbing material.

Referring now to FIGS. 5A and 5B, in some instances disposable bed linen 10 further comprises one or more structural features comprising a gripping surface 50 having a high COF to increase traction or grip between the user and the user contact surface 12. In some embodiments, gripping surface 50 comprises a contrasting fabric or material that is applied to various areas of user contact surface 12 to be easily accessible by the user's hands, forearms, elbows and/or feet when lying thereon. For example, in some instances gripping surface 50 comprises a fabric having a high COF against the user's skin, such as felt or flannel. In some instances, gripping surface 50 comprises a material having a high COF against the user's skin, such as silicon, latex, nitrile or a similar type of material.

In some instances, gripping surface 50 is applied to user contact surface 12 through a mechanical bond, such as stitching or via an adhesive. In some instances, gripping surface 50 is applied to user contact surface 12 through extrusion followed by curing.

Referring now to FIG. 5A, in some instances user contact surface 12 comprises one or more gripping surfaces 52 that are positioned in proximity to the user's arms, and specifically the user's forearms, elbows and/or hands, so that the user may easily contact gripping surfaces 52 to assist the user in repositioning themselves on user contact surface 12. In some instances, gripping surface 52 are placed on the outer edges of user contact surface 12 so as to avoid contact with the user's body. Similarly, user contact surface may further include one or more gripping surface 54 that are positioned in proximity to the user's feet so that the user may easily contact gripping surfaces 54 with their feet or heels to assist the user in repositioning themselves on user contact surface 12.

Referring now to FIG. 5B, in some instances user contact surface 12 comprises one or more elongated gripping surfaces 56. Elongated gripping surface 56 provides a single gripping surface which spans the entire distance between the user's hands and feet. As such, gripping surface 56 may be used for users of varying heights. In some instances, the continuous surface of gripping surface 56 eliminates stretch in user contact surface 12 that may exist in the embodiment shown in FIG. 5A. Gripping surface 56 also permits the user to contact and use gripping surface 56 from a wider range of positions and configurations on user contact surface 12.

The present invention may be embodied in other specific forms without departing from its structures, methods, or other essential characteristics as broadly described herein and claimed hereinafter. For example, one having skill in the art will appreciate that the systems and methods of the present invention may be adapted to include any combinations of the features described herein. Thus, the described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A disposable bed linen, comprising:
a user contact surface having a head end and a foot end; and
a therapeutic sensory feature selected from the group consisting of a color, a scent, a texture, and a pattern.

2. The disposable bed linen of claim 1, wherein the bed linen is selected from the group consisting of fitted sheets, flat sheets, top sheets, bottom sheets, coverlets, bedspreads, blankets, throws, comforters, duvets, duvet covers, pillows, pillow cases, pillow shams, and bed skirts.

3. The disposable bed linen of claim 1, wherein the scent is derived from at least one of an essential oil, an aromatic or aroma compound, an odorant, an aroma, a fragrance, an oil, and a flavor.

4. The disposable bed linen of claim 1, wherein the therapeutic sensory feature is selected to relieve a user condition selected from the group consisting of anxiety, fatigue, indigestion, stress, pain, depression, and tension.

5. The disposable bed linen of claim 1, wherein the color is selected to relieve a user condition selected from the group consisting of anxiety, fatigue, indigestion, stress, pain, depression, and tension.

6. The disposable bed linen of claim 1, further comprising:
a sidewall; and
a handle formed in the sidewall.

7. The disposable bed linen of claim 6, wherein the sidewall comprises a plurality of handles.

8. The disposable bed linen of claim 6, wherein the handle further comprises reinforced stitching around a perimeter of the handle.

9. The disposable bed linen of claim 6, wherein the handle is positioned on the sidewall in alignment with one or more air vents of a mattress when the disposable bed linen is installed on the mattress.

10. The disposable bed linen of claim 1, further comprising padding at the head end or the foot end.

11. The disposable bed linen of claim 1, further comprising a pocket at the head end or the foot end, wherein the pocket comprises padding.

12. The disposable bed linen of claim 10, wherein the padding comprises a moisture wicking material.

13. The disposable bed linen of claim 10, wherein the padding comprises a heat absorbing material.

14. The disposable bed linen of claim 1, further comprising a gripping surface applied to various areas of the user contact surface.

15. The disposable bed linen of claim 14, wherein the gripping surface comprises a material selected from the group consisting of silicon, latex, and nitrile.

16. A disposable clothing item comprising a therapeutic sensory feature selected from the group consisting of a color, a scent, a texture, and a pattern.

17. The disposable clothing item of claim 16, wherein the scent is derived from at least one of an essential oil, an aromatic or aroma compound, an odorant, an aroma, a fragrance, an oil, and a flavor.

18. The disposable clothing item of claim 16, wherein the therapeutic sensory feature is selected to relieve a user condition selected from the group consisting of anxiety, fatigue, indigestion, stress, pain, depression, and tension.

19. The disposable clothing item of claim 16, wherein the color is selected to relieve a user condition selected from the group consisting of anxiety, fatigue, indigestion, stress, pain, depression, and tension.

20. The disposable clothing item of claim 16, further comprising at least one of an antimicrobial agent, a waterproof coating, and moisture wicking properties.
